(19) United States
(12) Patent Application Publication
(10) Pub. No.: US 2011/0171010 A1
(43) Pub. Date: Jul. 14, 2011

(54) Sealing System Between a Shroud Segment and a Rotor Blade Tip and Manufacturing Method for Such a Segment

(76) Inventors: Xin-Hai Li, Linkoping (SE); Sergey Shukin, Finspong (SE)

(21) Appl. No.: 13/001,800

(22) PCT Filed: Jul. 2, 2009
(86) PCT No.: PCT/EP09/58311

§ 371 Date: Mar. 31, 2011

(30) Foreign Application Priority Data
Jul. 3, 2008 (EP) 08012063.7

(51) Int. Cl. F01D 11/08; B23P 11/00

(52) U.S. Cl. 415/173.1; 29/888

(57) ABSTRACT

An arrangement including a turbine blade is provided. The turbine blade includes at least a root, an airfoil and a tip which is mounted to a rotor by means of the root. The rotor extends along a machine axis. The arrangement also includes a circumferential casing segment which includes a surface. The surface faces tips of the blades, wherein the surface is structured. A method to produce a casing segment is also provided. In order to increase efficiency without limiting the operational range of the turbine, the surface is provided at least partially with an at least partially ceramic coating. The method includes machining a first structure into the surface and providing the surface with a ceramic coating.

### CROSS REFERENCE TO RELATED APPLICATIONS

This application is the US National Stage of International Application No. PCT/EP2009/058311, filed Jul. 2, 2009 and claims the benefit thereof. The International Application claims the benefits of European Patent Office application No. 08012063.7 EP filed Jul. 3, 2008. All of the applications are incorporated by reference herein in their entirety.

### FIELD OF INVENTION

The invention relates to an arrangement comprising a turbine blade, which comprises at least a root, an airfoil and a tip and which is mounted to a rotor by means of its root, which rotor is extending along a machine axis and a circumferential casing segment, which is comprising a surface, which is facing tips of the blades, wherein the surface is structured. Further the invention relates to a method to produce a casing segment, which casing segment comprises a surface, which is facing blade tips of turbine blades, which are mounted to a rotor, which is extending rotatable along a machine axis.

### BACKGROUND OF INVENTION

The most important aim of the development in the field of modern gas turbines is the improvement of the efficiency. Further important aspects are flexibility in operation, low maintenance costs, high availability and low emissions. The latter object is directly related to the improvement of efficiency, wherein a secondary feature is the stability in operation.

Basic thermodynamics reveal that higher gas temperatures are one possibility to increase the efficiency of a gas turbine. Temperature limiting factors are in first instance the materials used for the components having direct contact to the hot gas. To exceed limits for the gas temperature set by the material of for example the blades or casing segments facing the blade tips in modem gas turbines complex cooling is provided for example by channels for cooling air in blades. In several applications a thin cooling air film is established on the top of the surfaces facing the hot gas.

Even higher temperatures are made possible by additional thermal barrier coatings insulating the basic material of these components having low heat conductivity. One example can be found in WO 2007/115839 A2.

Next to temperature relating approaches to increase the efficiency also fluid dynamic measures are taken to increase the relative power output of a gas turbine. One possibility is the lowering of the amount of secondary flow through a gap between the tip of a rotating blade and the opposing surface of a casing segment. This can be done by the reduction of the clearance between the stationary and the rotating part.

On the other hand these clearances must not be diminished below a gap, which might be bridged over by especially thermal expansions during non-steady state operating conditions especially during start up to avoid a contact between rotating and stationary parts. Such a rubbing event might result in a catastrophic failure.

Blade tips and corresponding opposing surfaces facing the tips with highest relative velocities are subjected to extreme thermal impact due to the high operating temperatures combined with aerodynamic friction. The turbulences of the hot gases passing through the gap between the blade tips and the heat shield blades cause highest thermal impact to the blade tips and the opposing surfaces of the casing segments.

### SUMMARY OF INVENTION

Therefore it is one object of the invention to provide an arrangement of the incipiently mentioned type enabling highest operating temperatures and best fluid dynamic performance in the area of the gaps between rotating blades and opposing casing segments without reducing operational safety or the operational range of a gas turbine. Further it is an object of the invention to provide a method to produce a casing segment of such an arrangement.

These objects are achieved by an arrangement in accordance with the claims respectively by a method to produce a casing segment in accordance with the claims. The dependent claims are referring to beneficial embodiments respectively.

A machine axis according to the invention is the axis of rotation of a rotor carrying blades especially of a gas turbine.

The invention especially refers to gas turbines but is also appreciable to other rotating machines in cooperating rotating blades, for example steam turbines or compressors.

A circumferential surface according to the invention is an element carrying the surface, which faces the tips of the rotating blades of the rotational machine. Herein the tip of the blades refers to the regularly outermost edge of the blades airfoil. This edge normally extends along the cord length of the cross sectional profile of the airfoil.

Because of thermal expension of the rotating blades in axial direction during engine operation, the structuring of the surface element rubs into the blade tips fixating a corresponding structuring on the blades tips facing to the casing segment. This structuring suppresses unwanted secondary flows more efficient than a plain surface. The structuring consists of a plurality of recesses or protrusions or grooves or might be a honeycomb pattern. The grooves preferably extend in a circumferential direction.

The provision of the ceramic coating on the surface enables to customize the surface properties in a beneficial way without changing the basic material of the casing segment, which needs to be suitable for machining of the surface structure. According to the method provided by the invention the structure is machined into the surface and the surface is provided with a ceramic coating afterwards. Advantageously a surface having beneficial material properties particularly chosen for a better operational behavior is combined with a surface geometry improving the aerodynamics.

Machining according to the invention can be done by turning, milling, grinding, electronic discharge machining or any other suitable method.

A preferred embodiment of the method according to the invention provides a further production step after the application of the at least partially ceramic coating by machining the protrusions of the surface to a certain minimum diameter. Since coating methods do not necessarily result in highest geometric accuracy, the subsequent step of machining guarantees sufficient operational clearances between rotating blades and opposing surfaces of the casing segments.

According to a preferred embodiment of the invention the structure of the surface comprises circumferential grooves. These grooves can be separated from each other by circumferential protrusions of for example triangular cross section. Further the grooves themselves can be of triangular cross section. This structure geometry results in an improved sealing effect.

One especially beneficial embodiment is provided by a thermal barrier coating as a coating of the surface facing the blade's tips. Preferably this coating has a thermal conductivity between 0.3 and 3 W/mK. Further a preferred embodiment of the invention provides the coating as an abradable coating, which is preferably abradable by a tip of the blade. The abradablity in this context means that the abrading element and the abraded element are both not destructed and that the abraded element is diminished by the abrading element respectively the blade's tip machines the surface of the casing segment according to the invention.

Another embodiment of the invention provides a cooling system of cooling the casing segment. By cooling the casing segment the temperature difference between the hot gases flowing along the surface and the casing segment's basic material can be increased. Especially, when the coating is at least partially a thermal barrier coating.

Preferably the coating has a thickness of approximately 100 μm to 3000 μm, which leads to a good insulation effect.

One preferred embodiment of the invention provides the coating as a layer system comprising at least a first layer, which is directly applied to the surface of the basic material respectively the substrate as a bonding layer and a second layer as an insulating layer which may possess abradable function. Especially when the bonding layer is a thin metallic layer the lifetime of the coating can be lengthened. Preferably the second layer is a ceramic layer, which preferably contains mainly zirconium oxide together with an amount of stabilizing oxide.

For good abradablity the second layer can be of porosity between 15-50 vol %.

A beneficial coating method for the second layer is plasma spraying especially atmospheric plasma spraying, low pressure plasma spraying, vacuum plasma spraying or plasma enhanced chemical vapor deposition.

Coating adhesion can also benefit from the groove structure on the casing segments.

### BRIEF DESCRIPTION OF THE DRAWINGS

The above mentioned attributes and other features and advantages of this invention and the manner of attaining them will become more apparent and the invention itself will be better understood by reference to the following description of the currently best mode of carrying our the invention taken in conjunction with the companying drawings, wherein:

FIG. 1 shows a schematic depiction of an arrangement according to the invention comprising a gas turbine blade and a casing segment with a surface facing the tip of the blade,

FIG. 2 shows schematically a detail of FIG. 1, respectively the surface of the casing segment covered with a coating after the final production step.

### DETAILED DESCRIPTION OF INVENTION

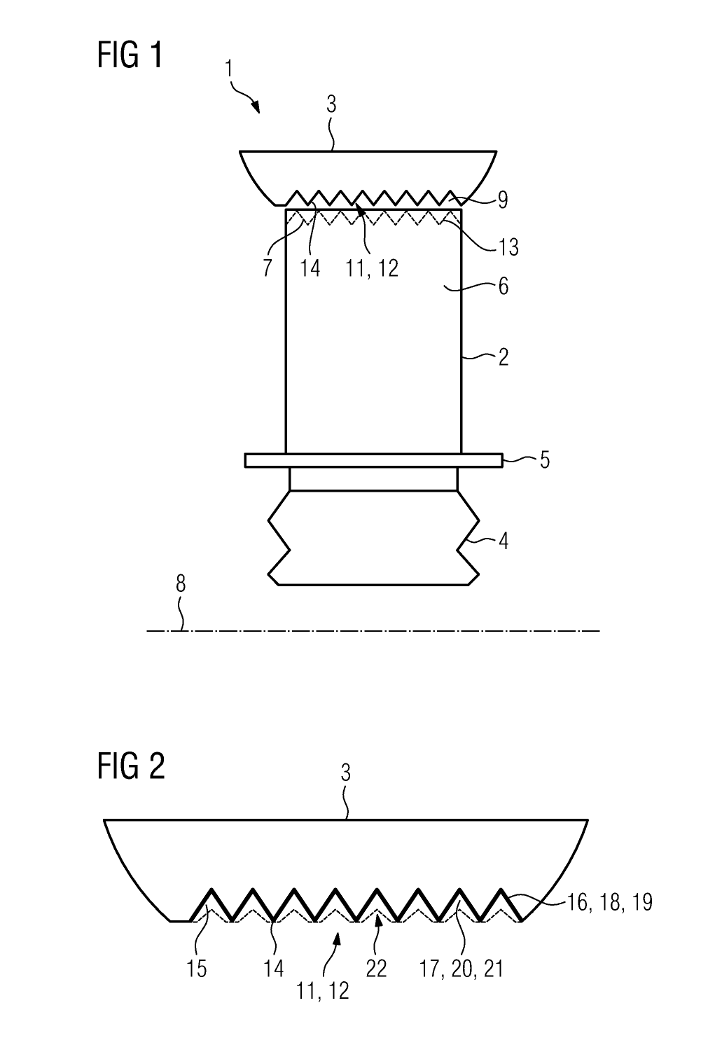

FIG. 1 shows an arrangement 1 according to the invention comprising a gas turbine blade 2 and a casing segment 3.

The gas turbine blade 2 consists of a blade root 4, a platform 5 and an airfoil 6 radially ending in a blade tip 7. The blade 2 is mounted in a not shown manner in a not shown rotor extending along a machine axis 8 respectively the rotational axis of the rotor. The casing segment 3 circumferences the rotor.

A gap 9 between the blade's tip 7 and a surface 11 of the casing segment 3 facing the blade's tip 7 is provided to maintain the necessary clearance between the rotating parts and the stationary parts. The surface 11 is provided with a first surface structure 12, which improves the aerodynamic efficiency by inhibiting the secondary flow over the blades tip 7, which's bypassing diminishes the power output. The saw-teeth like structure 12 consists of circumferential grooves 22 of triangular cross sectional shape separating circumferential protrusions 14 of triangular shape. The blade tip 7 has initially before operation a flat tip surface without any structure.

After the first start the protrusions 14 grind a corresponding second surface structure 13 of a corresponding shape into the blade's tip (dotted line in FIG. 1), resulting in saw teeth like second protrusions.

FIG. 2 shows details of the surface 11 in a final state after the application of a partial ceramic coating 14 and a machining of the tips of the protrusions 14 of the first structure 12.

The coating 15 comprising a layer system consisting of a first layer 18, respectively a bonding layer 16 and a second layer 20, respectively a ceramic layer 21, provided as a thermal barrier coating 17. The bonding layer 16 is a thin metallic layer of the MCrAlY-type alloy (MCrAlY). The coating has an overall thickness of 50-300 μm and a thermal barrier coating 17 has a thermal conductivity between 0.3-3 W/mK. The thermal barrier coating 17 is applied with porosity between 15-50 vol % and contains mainly zirconium oxide together with an amount of a stabilizing oxide. The second layer 20 respectively the thermal barrier coating 17 is applied by plasma spraying preferably atmospheric plasma spraying.

The coating 15 is abradable, which enables a very tight radial clearance resulting in a high efficiency without the danger of failure by rubbing.

1-19. (canceled)

20. An arrangement, comprising:
a turbine blade, comprising:
a root;
an airfoil with a tip; and
a circumferential casing segment, comprising:
a surface facing a plurality of tips of a plurality of turbine blades,
wherein the turbine blade is mounted to a rotor using the root,
wherein the rotor extends along a machine axis,
wherein the surface is structured, and
wherein the surface is provided at least partially with an at least partially ceramic coating.

21. The arrangement according to claim 20, wherein the coating is a thermal barrier coating.

22. The arrangement according to claim 21, wherein a heat conductivity of the thermal barrier coating is between 0.3-3 W/mK.

23. The arrangement according to claim 20, wherein the coating is abradable.

24. The arrangement according to claim 23, wherein the coating is abradable by the tip of the turbine blade.

25. The arrangement according to claim 20, wherein the casing segment is cooled by a cooling system.

26. The arrangement according to claim 20, wherein the coating includes a thickness between 100-3000 μm.

27. The arrangement according to claim 20, wherein the coating is a layer system comprising a first layer, which is directly applied to the surface as a bonding layer and a second layer, which is an insulating layer.

28. The arrangement according to claim 27, wherein the bonding layer is a thin metallic layer.

29. The arrangement according to claim 27, wherein the second layer is a ceramic layer.

30. The arrangement according to claim 29, wherein the ceramic layer comprises zirconium oxide or yttrium oxide.

31. The arrangement according to claim 30, wherein the ceramic layer comprises mostly zirconium oxide.

32. The arrangement according to claims 27, wherein the second layer includes a porosity between 15-50 vol %.

33. The arrangement according to claims 27, wherein the second layer is applied by atmospheric plasma spraying, low pressure plasma spraying, vacuum plasma spraying or chemical vapor deposition.

34. A method to produce a casing segment, comprising:
providing a casing segment including a surface;
machining a first structure into the surface; and
coating the surface with a ceramic coating,
wherein the surface faces a plurality of blade tips of a plurality of turbine blades, and
wherein the plurality of turbine blades are mounted to a rotor, which extends rotatable along a machine axis.

35. The method according to claim 34, further comprising machining a plurality of protrusions of the surface structure of a plurality of casing segments to a certain diameter after the coating.

36. The method according to claim 34, wherein the first structure comprises a plurality of circumferential grooves.

37. The method according to claim 36, wherein the plurality of circumferential grooves are separated from each other by a circumferential protrusion of triangular cross section respectively.

38. The method according to claim 37, wherein the plurality of circumferential grooves include a triangular cross section.

39. The method according to claim 34, wherein the coating is a thermal barrier coating.
